(19) United States
(12) Patent Application Publication
(10) Pub. No.: US 2025/0326637 A1
(43) Pub. Date: Oct. 23, 2025

(54) BIOGAS REFORMING SYSTEM

(71) Applicants: HYUNDAI MOTOR COMPANY, Seoul (KR); KIA CORPORATION, Seoul (KR); HYUNDAI ENGINEERING AND CONSTRUCTION CO., LTD., Seoul (KR); Research & Business Foundation SUNGKYUNKWAN UNIVERSITY, Suwon-si (KR)

(72) Inventors: Haeun Jeong, Hwaseong-si (KR); Pyungsoon Kim, Hwaseong-si (KR); Kyung Soo Park, Hwaseong-si (KR); Duk-Young Hwang, Yongin-si (KR); Yong-Kwan Kim, Yongin-si (KR); Ki-Cheol Jung, Seoul (KR); Jiyong Kim, Suwon-si (KR); Hegwon Chung, Seoul (KR)

(73) Assignees: HYUNDAI MOTOR COMPANY, Seoul (KR); KIA CORPORATION, Seoul (KR); HYUNDAI ENGINEERING AND CONSTRUCTION CO., LTD., Seoul (KR); Research & Business Foundation SUNGKYUNKWAN UNIVERSITY, Suwon-si (KR)

(21) Appl. No.: 18/965,346

(22) Filed: Dec. 2, 2024

(30) Foreign Application Priority Data
Apr. 22, 2024 (KR) 10-2024-0053431

(51) Int. Cl. C01B 3/38; B01D 53/02; B01D 53/14; B01J 19/00

(52) U.S. Cl. CPC C01B 3/38; B01D 53/02; B01D 53/1475; B01J 19/0013; B01D 2252/20484; B01D 2253/108; B01D 2256/16; B01D 2257/304; B01D 2257/502; B01D 2257/504; B01D 2257/80; B01D 2258/05; B01J 2219/00103; B01J 2219/00157; C01B 2203/0233; C01B 2203/0238; C01B 2203/047; C01B 2203/0475; C01B 2203/0827; C01B 2203/1235; C01B 2203/1258

(57) ABSTRACT

A biogas reforming system includes a desulfurization part configured to remove sulfur components from biogas, a mixed reforming part configured to produce hydrogen (H₂) and carbon monoxide (CO) by performing a mixed reforming reaction on methane (CH₄) in the biogas, which has passed through the desulfurization part, with steam (H₂O) and carbon dioxide (CO₂), a hydrogen separation part configured to separate hydrogen (H₂) from a reaction product from the mixed reforming part, and a heat supply part configured to supply heat to the mixed reforming part by combusting the reaction product having passed through the hydrogen separation part, and a part of the biogas having passed through the desulfurization part.

### CROSS-REFERENCE TO RELATED APPLICATION

This application claims priority to and the benefit of Korean Patent Application No. 10-2024-0053431 filed in the Korean Intellectual Property Office on Apr. 22, 2024, the entire contents of which are incorporated herein by reference.

### BACKGROUND

### (a) Technical Field

The present disclosure relates to a biogas reforming method, and more particularly, to a biogas reforming method based on a carbon dioxide (CO₂) composite reforming system.

### (b) Description of the Related Art

Recently, there has been an active global effort to address climate change. Hydrogen is highly valuable as a clean energy source and energy storage means.

In the related art, only methane (CH₄) is separated from biogas from food waste or landfills and used for power generation. In this case, CO₂ is exposed to the atmosphere in an intact manner, which may cause global warming.

A commercially available gray hydrogen production process uses natural gas as a raw material and produces synthetic gas through a steam reforming reaction (SMR), and residual carbon monoxide is mostly converted into hydrogen through a WGS (Water Gas Shift) 1, 2 reaction, such that high-purity hydrogen is produced through a PSA (Pressure Swing Adsorption) 3 process.

Blue hydrogen, which is present during an intermediate carbon dioxide capture process in the gray hydrogen process, requires a slightly higher unit production cost compared to gray hydrogen, but reduces the amount of emission of carbon dioxide.

However, both the processes emit carbon dioxide, and thus there is a need for a method to further reduce the emission of carbon dioxide.

A natural gas-based hydrogen production process requires more costs and energy, and a WGS process emits carbon from methane as carbon dioxide. Therefore, the processes also need to be improved.

The statements in this Background section merely provide background information related to the present disclosure and may not constitute prior art.

### SUMMARY

According to one aspect, it is possible to provide a biogas reforming system that uses a mixed reforming method that uses carbon dioxide (CO₂) as a reactant at the time of producing hydrogen by reforming biogas to produce hydrogen, which is an energy storage, and carbon monoxide that may be a base of chemical fuel.

A biogas reforming system according to one aspect includes: a desulfurization part configured to remove sulfur components from biogas; a mixed reforming part configured to produce hydrogen (H₂) and carbon monoxide (CO) by performing a mixed reforming reaction on methane (CH₄) in the biogas, which has passed through the desulfurization part, with steam (H₂O) and carbon dioxide (CO₂); a hydrogen separation part configured to separate hydrogen (H₂) from a reaction product from the mixed reforming part; and a heat supply part configured to supply heat to the mixed reforming part by combusting the reaction product having passed through the hydrogen separation part, and a part of the biogas having passed through the desulfurization part.

The biogas reforming system may further include a carbon monoxide separation part configured to separate carbon monoxide from the reaction product having passed through the hydrogen separation part. The heat supply part is further configured to combust the reaction product having passed through the carbon monoxide separation part, and a part of the biogas having passed through the desulfurization part.

The desulfurization part may operate under a pressure condition in a range of 1 to 30 bar and a temperature condition in a range of 20 to 500° C.

The biogas having passed through the desulfurization part may include methane and carbon dioxide.

The steam and the methane may be supplied to the mixed reforming part with a molar ratio of the steam to methane in a range of 0.2 to 1.5.

The mixed reforming part may operate under a pressure condition in a range of 0.5 to 15 bar and a temperature condition in a range of 700 to 1000° C.

The biogas reforming system may further include a first heat exchange part configured to allow the biogas having passed through the desulfurization part and supplied to the mixed reforming part, and gas discharged from the heat supply part to exchange heat with each other.

The biogas reforming system may further include a second heat exchange part configured to allow the biogas having passed through the desulfurization part and supplied to the mixed reforming part, and the reaction product from the mixed reforming part to exchange heat with each other.

The biogas reforming system may further include a third heat exchange part configured to allow the steam supplied to the mixed reforming part and the reaction product from the mixed reforming part to exchange heat with each other.

The biogas reforming system may further include a liquid removing part provided between the mixed reforming part and the hydrogen separation part and configured to remove a liquid in the reaction product from the mixed reforming part.

The biogas reforming system may further include a pressurization part provided between the mixed reforming part and the hydrogen separation part and configured to increase a pressure of the reaction product from the mixed reforming part and provide the reaction product to the hydrogen separation part.

The biogas reforming system may further include a depressurization part provided between the hydrogen separation part and the carbon monoxide separation part and configured to decrease a pressure of the reaction product having passed through the hydrogen separation part, and provide the reaction product to the carbon monoxide separation part.

The biogas reforming system may further include a fourth heat exchange part configured to allow the reaction product having passed through the hydrogen separation part and the reaction product from the mixed reforming part to exchange heat with each other.

The biogas reforming system may further include a fifth heat exchange part configured to supply heat of gas, which is discharged from the heat supply part, to the desulfurization part.

The biogas reforming system may further include a carbon dioxide capturing part configured to capture carbon dioxide from gas discharged from the heat supply part.

The carbon dioxide capturing part may be configured to capture carbon dioxide by using one or more of absorption, adsorption, separation membrane, and cryogenic separation.

The biogas reforming system may further include a power generation part configured to produce electricity by extracting waste heat from gas discharged from the heat supply part.

The biogas reforming system according to one aspect uses the mixed reforming method that uses carbon dioxide (CO₂) as the reactant at the time of producing hydrogen by reforming methane to produce hydrogen, which is an energy storage, and carbon monoxide, which may be a base of chemical fuel, such that the amount of carbon dioxide emission may be reduced in the entire process.

### BRIEF DESCRIPTION OF THE DRAWINGS

FIG. 1 is a block flow diagram of a biogas reforming system according to one aspect of the present disclosure.

FIG. 2 is a block flow diagram of a biogas reforming system according to another aspect of the present disclosure.

FIG. 3 is a view illustrating an apparatus configuration of a biogas reforming system according to another aspect of the present disclosure.

FIG. 4 is a view illustrating an apparatus configuration of a biogas reforming system according to another aspect of the present disclosure.

FIG. 5 is a graph illustrating unit production costs in Examples 1 to 4.

FIG. 6 is a graph illustrating a net carbon dioxide equivalent emission amount in Examples 1 to 4.

FIG. 7 is a graph illustrating unit production price of hydrogen with respect to a hydrogen production amount in Examples 1 to 4.

The drawings described herein are for illustration purposes only and are not intended to limit the scope of the present disclosure in any way.

### DETAILED DESCRIPTION

Advantages and features to be described below and methods of achieving the advantages and features should be clear with reference to embodiments described in detail below together with the accompanying drawings. However, the implemented form is not limited to the embodiments disclosed herein. Unless otherwise defined, all terms (including technical and scientific terms) used in the present specification may be used as the meaning which may be commonly understood by the person with ordinary skill in the art, to which the present disclosure belongs. In addition, terms defined in a generally used dictionary shall not be construed in ideal or excessively formal meanings unless they are clearly and specially defined in the present specification.

Throughout the specification, unless explicitly described to the contrary, the word “comprise/include/have” and variations such as “comprises/includes/has” or “comprising/including/having” should be understood to imply the inclusion of stated elements, not the exclusion of any other elements.

In addition, unless particularly stated otherwise, a singular form also includes a plural form.

When a component, part, device, element, apparatus, or the like of the present disclosure is described as having a purpose or performing an operation, function, or the like, the component, part, device, element, apparatus, or the like should be considered herein as being “configured to” meet that purpose or to perform that operation or function.

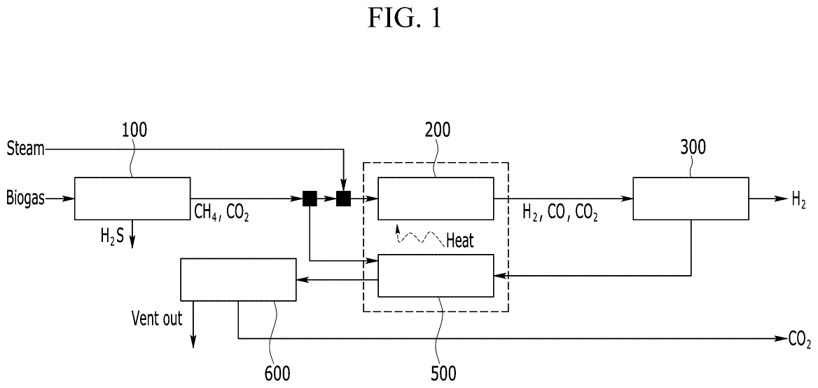

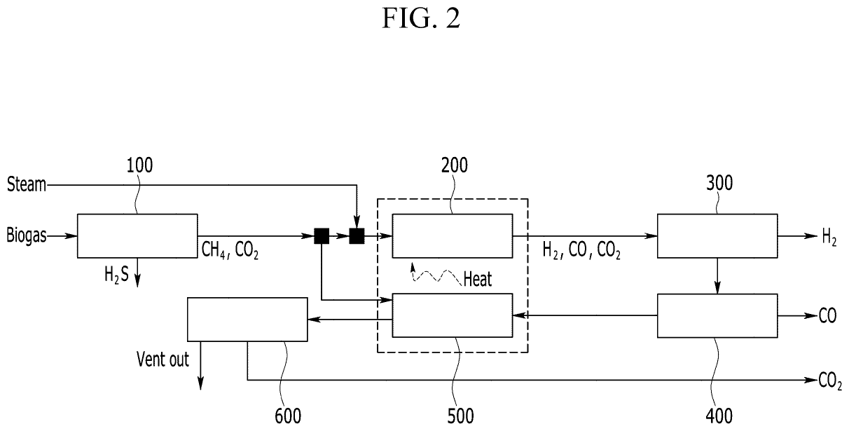

FIG. 1 is a block flow diagram of a biogas reforming system according to one aspect of the present disclosure, and FIG. 2 is a block flow diagram of a biogas reforming system according to another aspect of the present disclosure. Hereinafter, the biogas reforming system is described in detail with reference to FIGS. 1 and 2. FIGS. 1 and 2 illustrate essential components of the biogas reforming system according to one aspect, and additional components may be added to the biogas reforming system, as necessary.

As illustrated in FIG. 1, the biogas reforming system includes a desulfurization part 100, a mixed reforming part 200, a hydrogen separation part 300, and a heat supply part 500.

Biogas may be supplied at a supply rate of 1 to 10 kmol/h. The supply rate of the biogas may increase in proportion to a size of the mixed reforming part 200 and a capacity of a catalyst.

The biogas may include carbon dioxide (CO₂), nitrogen (N₂), hydrogen sulfide (H₂S), and methane (CH₄) before the biogas is supplied to the desulfurization part 100. Specifically, the biogas may include CH₄ of 30 to 80 mol %, CO₂ of 20 to 70 mol %, N₂ of 5 mol % or less, and H₂S of 0.1 mol % or less. More specifically, the biogas may include CH₄ of 45 to 65 mol %, CO₂ of 35 to 55 mol %, N₂ of 3 mol % or less, and H₂S of 0.05 mol % or less.

The desulfurization part 100 removes sulfur components from hydrocarbon gas.

It is necessary to remove in advance the sulfur components included in the biogas because the sulfur components act as a catalyst poison that degrades the activity of the catalyst used in the mixed reforming part 200 at the rear end.

For example, the desulfurization part 100 may use adsorptive desulfurization or hydro-desulfurization.

The desulfurization part 100 may operate under a pressure condition of 1 to 30 bar and a temperature condition of 20 to 500° C. If a reaction temperature of the desulfurization part 100 is too low, a reaction rate and desulfurization may not be sufficient. If the reaction temperature is too high, a sulfur adsorption rate may decrease. In addition, if a reaction pressure of the desulfurization part 100 is too low, the desulfurization may not be sufficient. If the reaction pressure is too high, the apparatus configuration costs may increase. More specifically, the desulfurization part 100 may operate under a pressure condition of 5 to 20 bar and a temperature condition of 300 to 500° C.

For example, the desulfurization part 100 may operate so that the content of the sulfur components in the hydrocarbon gas is 0.01 mol % or less. More specifically, the desulfurization part 100 may operate so that the content of the sulfur components is 0.001 mol % or less. As a result, the biogas having passed through the desulfurization part 100 includes methane and carbon dioxide. Specifically, the biogas may include CH₄ of 30 to 80 mol %, CO₂ of 20 to 70 mol %, and N₂ of 5 mol % or less. More specifically, the biogas may include CH₄ of 45 to 65 mol %, CO₂ of 35 to 55 mol %, and N₂ of 3 mol % or less.

The mixed reforming part 200 produces hydrogen (H₂) and carbon monoxide (CO) by performing a mixed reforming reaction on methane (CH₄) in the biogas having passed through the desulfurization part with steam (H₂O) and carbon dioxide (CO₂).

The mixed reforming reaction occurring in the mixed reforming part 200 may be an endothermic reaction and represented by Reaction Formula 1 below.

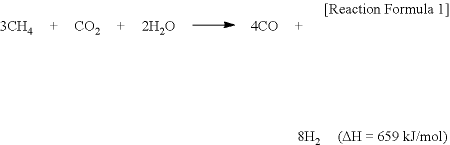

As shown in Reaction Formula 1, CO and H₂, which are the raw materials for reduced gases or high-value compounds, may be produced by converting CO₂, thereby reducing the amount of CO₂ emission in the entire process.

Thermal energy required for the reaction is supplied into the mixed reforming part 200 by the heat supply part 500.

The reaction product from the mixed reforming part 200 may include oxygen and carbon monoxide and include a small amount of unreacted methane and a small amount of carbon dioxide. The reaction product of the mixed reforming part 200 is separated into hydrogen gas and carbon monoxide gas by the hydrogen separation part 300 and a carbon monoxide separation part 400. The residual unreacted gas in the hydrogen separation part 300 and the carbon monoxide separation part 400 may recirculate to the heat supply part 500 and be used to supply the thermal energy.

The mixed reforming reaction may be performed by injecting and heat-treating methane (CH₄), steam (H₂O), and carbon dioxide (CO₂) in the biogas under the presence of the catalyst and performing the mixed reforming reaction. In this case, the steam may be separately injected by a first pump 221. In addition, carbon dioxide in the biogas may be used, or carbon dioxide may be injected separately.

In order to obtain hydrogen with the required composition, the mixed reforming reaction adjusts and supplies the molar ratio (volume ratio) between methane and steam. Specifically, the molar ratio of steam to methane (H₂O/CH₄) of 0.1 to 10 may be supplied. More specifically, a molar ratio of 0.2 to 1.5 may be supplied. More specifically, a molar ratio of 0.5 to 1.2 may be supplied. If the molar ratio of steam to methane (H₂O/CH₄) is too small, the conversion rate of methane is decreased, and the amount of carbon deposition is increased, which may cause deactivation of the catalyst. If the molar ratio is too large, the amount of produced hydrogen and carbon monoxide may be decreased. In addition, residual unreacted steam may promote deactivation of the catalyst.

The reaction temperature and pressure of the mixed reforming reaction may be adjusted appropriately depending on the required hydrogen composition. For example, the temperature and pressure conditions of the mixed reforming reaction may be a pressure of 0.5 to 15 bar and a temperature of 700 to 1000° C., for example, a pressure of 0.7 to 10 bar and a temperature of 800 to 950° C. If the reaction temperature is too low, the conversion rate of methane may be significantly lower, and if the reaction temperature is too high, thermal energy may be consumed inefficiently. In addition, if the reaction pressure is too high, the conversion rate of the reactant gas may be reduced, which may change the H₂/CO ratio.

After the reaction in the mixed reforming part 200, the biogas may include steam, carbon dioxide, nitrogen, carbon monoxide, hydrogen, and methane. Specifically, the biogas may include carbon monoxide of 10 to 50 mol %, hydrogen of 20 to 90 mol %, carbon dioxide of 10 mol % or less, steam of 10 mol % or less, nitrogen of 5 mol % or less, and methane of 1 mol % or less. More specifically, the biogas may include carbon monoxide of 20 to 40 mol %, hydrogen of 50 to 80 mol %, carbon dioxide of 5 mol % or less, steam of 5 mol % or less, nitrogen of 3 mol % or less, and methane of 0.5 mol % or less.

The hydrogen separation part 300 separates hydrogen (H₂) from the reaction product from the mixed reforming part 200.

In one example, the hydrogen separation part 300 may operate by using pressure swing adsorption, membrane separation, or cryogenic separation.

The hydrogen separation part 300 may separate hydrogen in consideration of the properties of the adsorbent or the separator, energy efficiency, and the like. For example, the hydrogen separation part 300 may separate hydrogen by using pressure swing adsorption.

In the hydrogen separation part 300, a recovery rate may be 91.9% or more, and a purity of hydrogen may be 99.99% or more.

In one aspect, the biogas reforming system may further include the carbon monoxide separation part 400 configured to additionally separate carbon monoxide from the reaction product having passed through the hydrogen separation part 300. The contents thereof are described with reference to FIG. 2.

The carbon monoxide separation part 400 may separate carbon monoxide by using pressure swing adsorption, membrane separation, or cryogenic separation. In the carbon monoxide separation part 400, a recovery rate of CO may be 90% or more, and a purity may be 99.9% or more.

The heat supply part 500 supplies heat to the mixed reforming part 200 by combusting the reaction product having passed through the hydrogen separation part 300 or the carbon monoxide separation part 400 and combusting a part of the biogas having passed through the desulfurization part 100.

For example, the heat supply part 500 may be configured as a burner or electric furnace.

For example, a front end of the mixed reforming part 200 is a portion in the biogas reforming system that requires the largest increase in temperature. Therefore, the heat generated by the heat supply part 500 may be supplied to the biogas and the steam supplied to the front end of the mixed reforming part 200. Alternatively, the heat may be supplied to a reactor of the mixed reforming part 200.

The heat supply part 500 may perform the combustion by receiving not only the reaction product having passed through the hydrogen separation part 300 or the carbon monoxide separation part 400 in addition to the desulfurization part 100, but also air for the combustion.

As illustrated in FIG. 1, when the biogas does not pass through the carbon monoxide separation part 400, the biogas reforming system may further include a power generation part 700 configured to produce electricity by extracting waste heat from the gas discharged from the heat supply part 500. The power generation part 700 produces electricity by converting water into steam by using the gas discharged from the heat supply part 500 and operating a turbine, cools the steam, which has been used to operate the turbine, and circulates the steam.

Selectively, the biogas reforming system may further include a carbon dioxide capturing part 600. The carbon dioxide capturing part 600 is positioned at a rear end of the heat supply part 500 and captures carbon dioxide from the gas discharged from the heat supply part 500.

The carbon dioxide capturing part 600 may capture carbon dioxide by using absorption, adsorption, a separation membrane, or cryogenic separation.

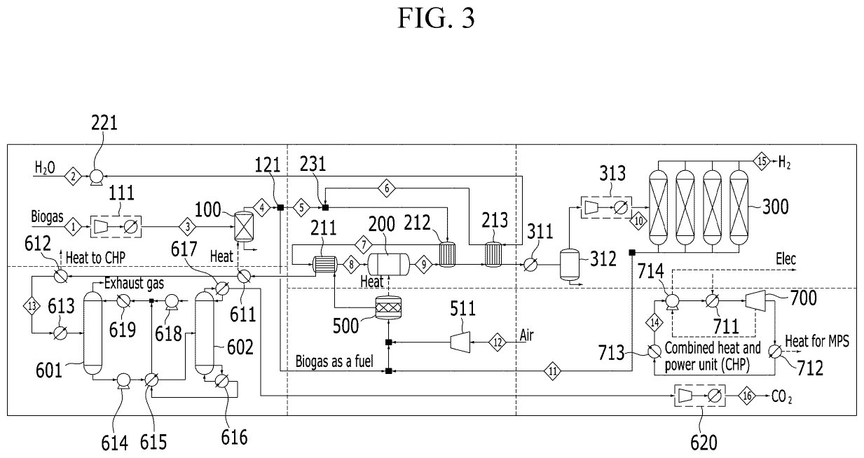

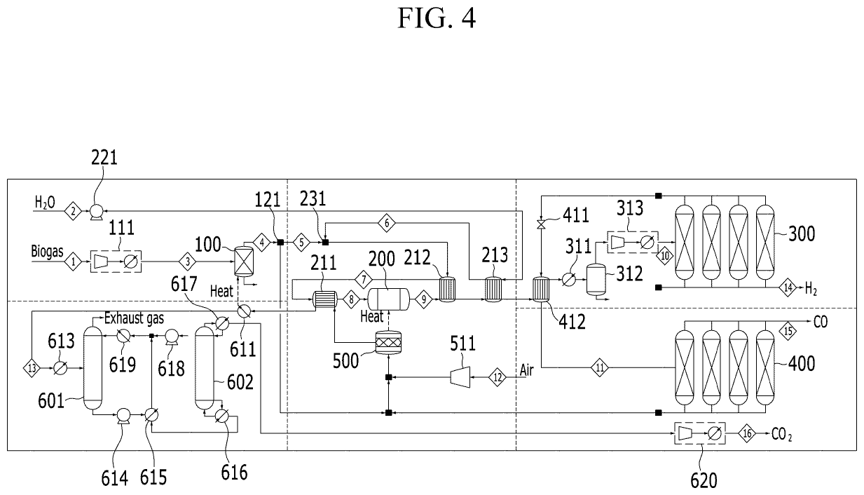

The apparatus configuration of the biogas reforming system is described more specifically with reference to FIGS. 3 and 4.

The pressure of the biogas is compressed to 1 to 30 bar by a first compressor 111.

Thereafter, H₂S of 0.05 mol % or less is separated while the biogas passes through the desulfurization part 100. Thereafter, a first flow is supplied to the mixed reforming part 200 and a second flow is supplied to the heat supply part 500 through a branching part 121.

The steam passes through the first pump 221, exchanges heat with the reaction product from the mixed reforming part 200 through a third heat exchange part 213, and then merges with the biogas, which has passed through the desulfurization part, in a merging part 231.

Thereafter, the steam exchanges heat with the reaction product from the mixed reforming part 200 through a second heat exchange part 212 and exchanges heat with the gas, which is discharged from the heat supply part, through a first heat exchange part 211, and the steam is supplied to the mixed reforming part 200. The first heat exchange part 211 is a heat exchanger using waste heat discarded from the heat supply part 500. The second heat exchange part 212 and the third heat exchange part 213 use waste heat that may be recovered from the reaction product from the mixed reforming part 200.

In the mixed reforming part 200, a temperature of the reaction product is decreased to a room temperature first by a first cooler 311 so that the hydrogen separation part 300 separates hydrogen, a liquid removing part 312 removes a liquid (mostly including water), and a second compressor 314 pressurizes the reaction product to pressure required for the hydrogen separation part 300.

After the separation of hydrogen, the remaining flow, together with the biogas used as fuel, is used as a raw material for the heat supply part 500. Air for an oxidation reaction is pressurized by a third compressor 511 and introduced into the heat supply part 500.

The heat supply part 500 is used to maintain the temperature of the mixed reforming part 200. The waste heat of the gas discharged from the heat supply part 500 is used to heat the biogas to the temperature required for the desulfurization part 100 through a fifth heat exchange part 611. The remaining waste heat is used for a combined heat and power (CHP) process through a sixth heat exchange part 612.

A second cooler 613 decreases a temperature of exhaust gas from the heat supply part 500, including carbon dioxide, to a room temperature. The carbon dioxide capturing part 600 may include an adsorption tower 601 and a desorption tower 602 for an amine absorption process. In the adsorption tower 601, an amine solution selectively adsorbs 90% or more of carbon dioxide from the exhaust gas from the heat supply part 500 (90% or more of a recovery rate of carbon dioxide), and an monoethanolamine (MEA)+CO₂ solution is introduced into the desorption tower 602 and separated into MEA and high-purity carbon dioxide. The separated carbon dioxide is pressurized by a fourth compressor 620 and has pressure that makes it easy to store or transport carbon dioxide. Because the separated amine solution has a high temperature, the solution is slightly lost when a second pump 614 and a seventh heat exchange part 615 increases a temperature of the MEA+CO₂ flow and separates the MEA+CO₂ flow. Therefore, a solution, which corresponds to the loss, is pressurized by a third pump 618 and then coupled to the separated amine solution, and a circulation flow is formed in which the solution exchanges heat in an eighth heat exchange part 619 and then is reused for the adsorption tower 601.

A flow rate of H₂O circulating in a combined heat and power unit (CHP) may be used as the amount of heat used for a ninth heat exchange part 711 through the sixth heat exchange part 612.

The water pressurized by a fourth pump 714 is converted into steam through the ninth heat exchange part 711, and the pressure of the steam is decreased to the pressure that may make medium-temperature, medium-pressure steam in the power generation part 700. The amount of heat, which may use the medium-temperature, medium-pressure steam, may be obtained from a tenth heat exchange part 712, and a temperature is decreased to a room temperature by a third cooler 713 to circulate the used steam again.

Next, the apparatus configuration of the biogas reforming system is described more specifically with reference to FIG. 4. The same description with reference to FIGS. 3 and 4 has been omitted. FIG. 4 illustrates the apparatus configuration in which the biogas additionally passes through the carbon monoxide separation part 400 after the hydrogen separation part 300.

The pressure is decreased by a depressurization part 411 for the carbon monoxide separation performed at a lower pressure than the hydrogen separation after the hydrogen separation part 300. Thereafter, to meet the carbon monoxide separation condition, the reaction product having passed through the hydrogen separation part 300 and the reaction product from the mixed reforming part 200 exchange heat with each other through a fourth heat exchange part 412.

When the separation is performed through the carbon monoxide separation part 400, the cogeneration is not performed, unlike FIG. 1. Therefore, the heat exchange does not need to be performed, and a temperature of exhaust gas of the heat supply part 500 is decreased to a room temperature by using the second cooler 613.

Hereinafter, specific examples of the present disclosure are described. However, the examples described below are intended only to specifically illustrate and explain the present disclosure, and the scope of the present disclosure should not be limited thereto.

### [Examples: Simulation of Biogas Reforming System]

### Examples 1 and 2

In order to verify the effectiveness of the biogas reforming system according to the present aspect, a process simulation is performed with the Aspen Plus program. FIG. 3 illustrates the apparatus configuration of the biogas reforming system according to Examples 1 and 2. Because the description with respect to FIG. 3 has been described above, a redundant description has been omitted. An RGibbs reactor model was used as the mixed reforming part 200, and zeolite 5A was used as the adsorbent of the hydrogen separation part 300.

In Example 1, the conditions and material flow in each unit reactor are shown in Tables 1 and 2.

TABLE 1

| # of stream | 1 | 2 | 3 | 4 | 5 | 6 | 7 | 8 |
|---|---|---|---|---|---|---|---|---|
| Temp [° C.] | 35 | 30 | 30 | 350 | 350 | 269 | 631 | 900 |
| Pressure [bar] | 0.03 | 1 | 10 | 10 | 10 | 1 | 1 | 1 |
| Total flow rate [kmol/h] | 3.18 | 1.91 | 3.18 | 3.18 | 3.18 | 1.91 | 5.09 | 5.09 |
| H₂O | 0 | 1.91 | 0 | 0 | 0 | 1.91 | 1.91 | 1.91 |
| CO₂ | 1.24 | 0 | 1.24 | 1.24 | 1.24 | 0 | 1.24 | 1.24 |
| N₂ | 0.03 | 0 | 0.03 | 0.03 | 0.03 | 0 | 0.03 | 0.03 |
| Dioxygen (O₂) | 0 | 0 | 0 | 0 | 0 | 0 | 0 | 0 |
| CO | 0 | 0 | 0 | 0 | 0 | 0 | 0 | 0 |
| H₂ | 0 | 0 | 0 | 0 | 0 | 0 | 0 | 0 |
| H₂S | 0.002 | 0 | 0.002 | 0 | 0 | 0 | 0 | 0 |
| CH₄ | 1.91 | 0 | 1.91 | 1.91 | 1.91 | 0 | 1.91 | 1.91 |

TABLE 2

| # of stream | 9 | 10 | 11 | 12 | 13 | 14 | 15 | 16 |
|---|---|---|---|---|---|---|---|---|
| Temp [° C.] | 900 | 30 | 35 | 35 | 40 | 30 | 35 | 40 |
| Pressure [bar] | 1 | 34 | 34 | 1 | 1 | 1 | 1 | 150 |
| Total flow rate [kmol/h] | 8.9 | 8.05 | 3.59 | 7.88 | 9.88 | 4.48 | 4.46 | 2.84 |
| H₂O | 0.87 | 0.01 | 0.01 | 0 | 0.42 | 4.48 | 0 | 0.01 |
| CO₂ | 0.38 | 0.38 | 0.38 | 0 | 3.15 | 0 | 0 | 2.84 |
| N₂ | 0.03 | 0.03 | 0.03 | 6.22 | 6.25 | 0 | 0 | 0 |
| O₂ | 0 | 0 | 0 | 1.65 | 0.06 | 0 | 0 | 0 |
| CO | 2.76 | 2.76 | 2.76 | 0 | 0 | 0 | 0 | 0 |
| H₂ | 4.85 | 4.85 | 0.39 | 0 | 0 | 0 | 4.46 | 0 |
| H₂S | 0 | 0 | 0 | 0 | 0 | 0 | 0 | 0 |
| CH₄ | 0.01 | 0.01 | 0.01 | 0 | 0 | 0 | 0 | 0 |

In Example 2, the conditions and material flow in each unit reactor are shown in Tables 3 and 4.

TABLE 3

| # of stream | 1 | 2 | 3 | 4 | 5 | 6 | 7 | 8 |
|---|---|---|---|---|---|---|---|---|
| Temp [° C.] | 35 | 30 | 30 | 350 | 350 | 108 | 398 | 900 |
| Pressure [bar] | 0.03 | 1 | 10 | 10 | 10 | 1 | 1 | 1 |
| Total flow rate [kmol/h] | 2.98 | 5 | 2.98 | 2.98 | 2.98 | 5 | 7.76 | 7.76 |
| H₂O | 0 | 5 | 0 | 0 | 0 | 5 | 5 | 5 |
| CO₂ | 1.16 | 0 | 1.16 | 1.16 | 1.16 | 0 | 1.07 | 1.07 |
| N₂ | 0.03 | 0 | 0.03 | 0.03 | 0.03 | 0 | 0.03 | 0.03 |
| O₂ | 0 | 0 | 0 | 0 | 0 | 0 | 0 | 0 |
| CO | 0 | 0 | 0 | 0 | 0 | 0 | 0 | 0 |
| H₂ | 0 | 0 | 0 | 0 | 0 | 0 | 0 | 0 |
| H₂S | 0.001 | 0 | 0.001 | 0 | 0 | 0 | 0 | 0 |
| CH₄ | 1.79 | 0 | 1.79 | 1.79 | 1.79 | 0 | 1.65 | 1.65 |

TABLE 4

| # of stream | 9 | 10 | 11 | 12 | 13 | 14 | 15 | 16 |
|---|---|---|---|---|---|---|---|---|
| Temp [° C.] | 900 | 30 | 35 | 35 | 40 | 30 | 35 | 40 |
| Pressure [bar] | 1 | 34 | 34 | 1 | 1 | 1 | 1 | 150 |
| Total flow rate [kmol/h] | 11.06 | 7.62 | 3.16 | 6.66 | 8.97 | 0.61 | 4.46 | 2.66 |
| H₂O | 3.45 | 0.01 | 0.01 | 0 | 0.67 | 0.61 | 0 | 0.01 |
| CO₂ | 0.97 | 0.97 | 0.97 | 0 | 2.95 | 0 | 0 | 2.65 |
| N₂ | 0.03 | 0.03 | 0.03 | 5.26 | 5.29 | 0 | 0 | 0 |
| O₂ | 0 | 0 | 0 | 1.4 | 0.05 | 0 | 0 | 0 |
| CO | 1.76 | 1.76 | 1.76 | 0 | 0 | 0 | 0 | 0 |
| H₂ | 4.85 | 4.85 | 0.39 | 0 | 0 | 0 | 4.46 | 0 |
| H₂S | 0 | 0 | 0 | 0 | 0 | 0 | 0 | 0 |
| CH₄ | 0 | 0 | 0 | 0 | 0 | 0 | 0 | 0 |

In Example 1, the proportion of carbon monoxide produced is higher than in Example 2 because of the relatively small amount of steam. As a result, there is no additional biogas required as fuel in Example 1, whereas additional biogas is required in Example 2. In addition, Example 1 may produce predetermined amounts of electricity and medium-temperature, medium-pressure steam through CHP.

### Examples 3 and 4

FIG. 4 illustrates the apparatus configuration of the biogas reforming system according to Examples 3 and 4. Because the description with respect to FIG. 4 has been described above, a redundant description has been omitted.

In Example 3, the conditions and material flow in each unit reactor are shown in Tables 5 and 6.

TABLE 5

| # of stream | 1 | 2 | 3 | 4 | 5 | 6 | 7 | 8 |
|---|---|---|---|---|---|---|---|---|
| Temp [° C.] | 35 | 30 | 30 | 350 | 350 | 269 | 631 | 900 |
| Pressure [bar] | 0.03 | 1 | 10 | 10 | 10 | 1 | 1 | 1 |
| Total flow rate [kmol/h] | 4.78 | 1.91 | 4.78 | 4.77 | 3.18 | 1.91 | 5.09 | 5.09 |
| H₂O | 0 | 1.91 | 0 | 0 | 0 | 1.91 | 1.91 | 1.91 |
| CO₂ | 1.86 | 0 | 1.86 | 1.86 | 1.24 | 0 | 1.24 | 1.24 |
| N₂ | 0.05 | 0 | 0.05 | 0.05 | 0.03 | 0 | 0.03 | 0.03 |
| O₂ | 0 | 0 | 0 | 0 | 0 | 0 | 0 | 0 |
| CO | 0 | 0 | 0 | 0 | 0 | 0 | 0 | 0 |
| H₂ | 0 | 0 | 0 | 0 | 0 | 0 | 0 | 0 |
| H₂S | 0.002 | 0 | 0.002 | 0 | 0 | 0 | 0 | 0 |
| CH₄ | 2.87 | 0 | 2.87 | 2.87 | 1.91 | 0 | 1.91 | 1.91 |

TABLE 6

| # of stream | 9 | 10 | 11 | 12 | 13 | 14 | 15 | 16 |
|---|---|---|---|---|---|---|---|---|
| Temp [° C.] | 900 | 30 | 60 | 35 | 40 | 35 | 60 | 40 |
| Pressure [bar] | 1 | 34 | 9 | 1 | 1 | 1 | 1 | 150 |
| Total flow rate [kmol/h] | 8.9 | 8.05 | 3.59 | 11.18 | 13.53 | 4.46 | 2.49 | 2.02 |
| H₂O | 0.87 | 0.01 | 0.01 | 0 | 2.33 | 0 | 0 | 0 |
| CO₂ | 0.38 | 0.38 | 0.38 | 0 | 2.24 | 0 | 0 | 2.02 |
| N₂ | 0.03 | 0.03 | 0.03 | 8.83 | 8.87 | 0 | 0 | 0 |
| O₂ | 0 | 0 | 0 | 2.35 | 0.09 | 0 | 0 | 0 |
| CO | 2.76 | 2.76 | 2.76 | 0 | 0 | 0 | 2.49 | 0 |
| H₂ | 4.85 | 4.85 | 0.39 | 0 | 0 | 4.46 | 0 | 0 |
| H₂S | 0 | 0 | 0 | 0 | 0 | 0 | 0 | 0 |
| CH₄ | 0.01 | 0.01 | 0.01 | 0 | 0 | 0 | 0 | 0 |

In Example 4, the conditions and material flow in each unit reactor are shown in Tables 7 and 8.

TABLE 7

| # of stream | 1 | 2 | 3 | 4 | 5 | 6 | 7 | 8 |
|---|---|---|---|---|---|---|---|---|
| Temp [° C.] | 35 | 30 | 30 | 350 | 350 | 108 | 402 | 900 |
| Pressure [bar] | 0.03 | 1 | 10 | 10 | 10 | 1 | 1 | 1 |
| Total flow rate [kmol/h] | 4.14 | 4.96 | 4.14 | 4.14 | 2.76 | 4.96 | 7.72 | 7.72 |
| H₂O | 0 | 4.96 | 0 | 0 | 0 | 4.96 | 4.96 | 4.96 |
| CO₂ | 1.61 | 0 | 1.61 | 1.61 | 1.08 | 0 | 1.08 | 1.08 |
| N₂ | 0.04 | 0 | 0.04 | 0.04 | 0.03 | 0 | 0.03 | 0.03 |
| O₂ | 0 | 0 | 0 | 0 | 0 | 0 | 0 | 0 |
| CO | 0 | 0 | 0 | 0 | 0 | 0 | 0 | 0 |
| H₂ | 0 | 0 | 0 | 0 | 0 | 0 | 0 | 0 |
| H₂S | 0.002 | 0 | 0 | 0 | 0 | 0 | 0 | 0 |
| CH₄ | 2.48 | 0 | 2.48 | 2.48 | 1.65 | 0 | 1.65 | 1.65 |

TABLE 8

| # of stream | 9 | 10 | 11 | 12 | 13 | 14 | 15 | 16 |
|---|---|---|---|---|---|---|---|---|
| Temp [° C.] | 900 | 30 | 60 | 35 | 40 | 35 | 60 | 40 |
| Pressure [bar] | 1 | 34 | 9 | 1 | 1 | 1 | 1 | 150 |
| Total flow rate [kmol/h] | 11.03 | 7.62 | 3.16 | 9.61 | 12.27 | 4.46 | 1.59 | 2.26 |
| H₂O | 3.42 | 0.01 | 0.01 | 0 | 2.06 | 0 | 0 | 0.01 |
| CO₂ | 0.97 | 0.97 | 0.97 | 0 | 2.51 | 0 | 0 | 2.26 |
| N₂ | 0.03 | 0.03 | 0.03 | 7.59 | 7.63 | 0 | 0 | 0 |
| O₂ | 0 | 0 | 0 | 2.02 | 0.08 | 0 | 0 | 0 |
| CO | 1.76 | 1.76 | 1.76 | 0 | 0 | 0 | 1.59 | 0 |
| H₂ | 4.85 | 4.85 | 0.39 | 0 | 0 | 4.46 | 0 | 0 |
| H₂S | 0 | 0 | 0 | 0 | 0 | 0 | 0 | 0 |
| CH₄ | 0 | 0 | 0 | 0 | 0 | 0 | 0 | 0 |

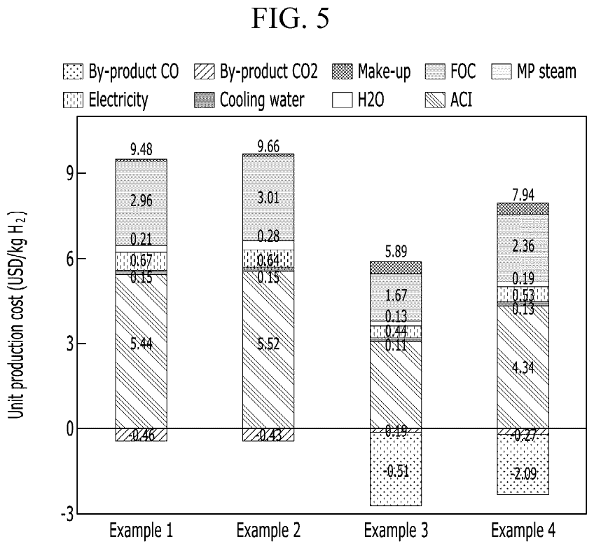

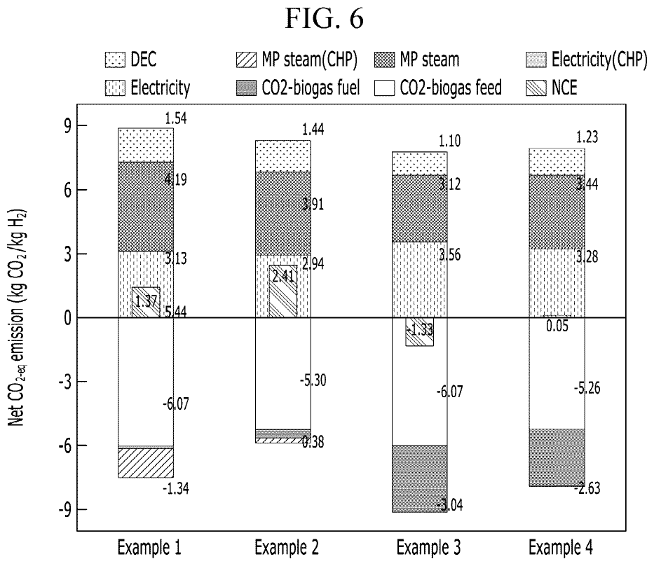

In Examples 1 to 4, unit production cost (UPC) and net CO₂-equivalent emission (NCE) were considered as economic and environmental evaluation indicators, and calculated as follows, and the results are shown in FIGS. 5 and 6.

Unit production cost (UPC): (Total production cost [$/yr])/(Mass flow rate of H₂ [kg/yr])

Net CO₂-equivalent emission (NCE): (Mass flow rate of CO₂ emission [kg/yr])/(Mass flow rate of H₂ [kg/yr])

FIG. 5 shows that each of the items, which constitute the UPC, represents an annually incurred cost (positive) consumed per annual hydrogen production or a revenue (negative) that may be generated in addition to the annual hydrogen production.

Fixed operating cost (FOC): Fixed operating costs including labor, overhead, and operational maintenance, management costs, and the like.

Annualized capital investment (ACI): Annualized capital investment costs calculated by multiplying total capital investment cost by annual factors that take into account interest and plant life.

H2O: Cost of steam required for mixed reforming reactions.

MP steam, electricity, cooling water: Cost of energy sources utilized as utilities for process.

Make-up: Additional adsorbent costs to be accounted for by loss of adsorbent in PSA (Pressure Swing Adsorption) process and additional costs of MEA solution lost in CO₂ capture fixation.

By-product CO, CO2: Costs that may be reduced by selling by-products that may be generated in addition to hydrogen.

FIG. 6 shows that each of the items, which constitute the NCE, represents annual amount (positive) of carbon dioxide generated per annual hydrogen production, or annual amount (negative) of carbon dioxide consumed through use.

Direct CO2 emission (DCE): Carbon dioxide emitted directly from flow of process.

Combined heat and power (CHP) process: Cogeneration plant process.

MP steam (CHP), Electricity (CHP) refers to the utilities generated by the cogeneration plant.

CO₂-biogas fuel: Carbon dioxide reduced from biogas used as fuel.

CO₂-biogas feed: Considered amount of carbon dioxide reduced from biogas used as raw material.

MP steam, Electricity: Amount of carbon dioxide emitted indirectly from utilities utilized in process.

When comparing the unit production costs in Examples, Example 3 shows the most economic advantage at 5.89 $/kg.

The results show that ACI and FOC account for the largest components among the components of the unit production costs.

ACI stands for Annualized Capital Investment, FOC stands for Fixed Operating Cost, and the results show that a large amount of initial investment costs are incurred.

It can be seen that the strategy of selling carbon monoxide as a by-product in Examples 3 and 4 shows prominent results. In particular, the larger UPC reduction is shown in Example 3 in which the amount of steam is relatively small.

The results of the environmental assessment with NCE show that the final NCE values are equal to or less than zero in Example 3 and close to zero in Example 4.

It can be seen that the biogas reforming system proposed in the present disclosure is green hydrogen with the carbon reduction effect.

In addition, when comparing the carbon emission effects of NCE, the process using CO as fuel uses less electricity than the process with CO capture. However, the amount of use of medium-temperature and medium-pressure steam and the DCE (Direct CO₂ Emission) value, which is the amount of direct CO₂ emissions, are large.

In Examples 3 and 4, the pressurization device is required because of the carbon monoxide separation part, which increases the electricity usage, but the amount of carbon dioxide emission is small because less CO flows into the heat supply part 500. In addition, the amount of carbon dioxide emission generated by the heat supply part 500 is reduced, which reduces the amount of medium-temperature, medium-pressure steam utilized as a utility in the CO₂ capture process. However, Examples 1 and 2 have relatively large amounts of CO₂ emissions because CO is used as fuel and converted back into CO₂.

It has been found that the present technology enables the carbon dioxide reduction due to the use of biogas to be verified, and that Embodiment 3 is particularly effective in reducing carbon dioxide in the process.

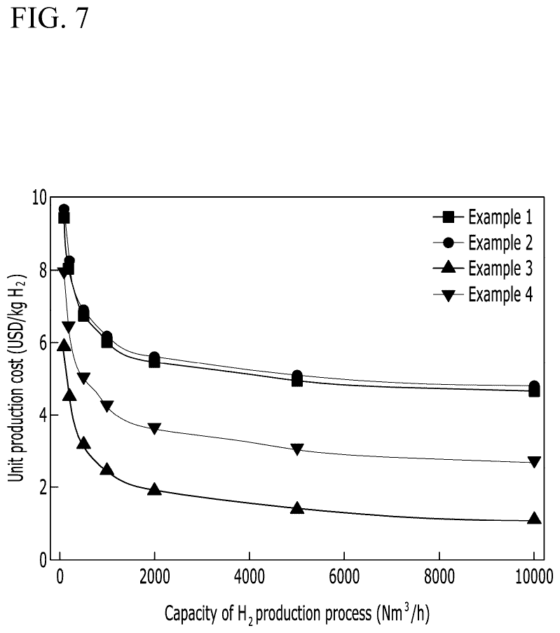

A sensitivity analysis of the processes of Examples 1 to 4 to the unit production price of hydrogen at assumed scales ranging from 100 Nm³/h to 10,000 Nm³/h was performed and the results are shown in FIG. 7.

FIG. 7 shows the convergence of the unit production cost around 2,000 Nm³/h.

In particular, Example 3 shows the convergence at 2 $/kg at the 2,000 Nm³/h scale. This is a market competitive result compared to the current price of green hydrogen production (3-8 $/kg, source: International Energy Agengy (IEA) 2021) and the hydrogen price in 2022 in Korea of 6,000 KRW/kg (source: Korea Hydrogen Fuel Cell Industry Association).

Although embodiments of the present disclosure have been described in detail hereinabove, the right scope of the present disclosure is not limited thereto, and many variations and modifications of those having ordinary skill in the art using the basic concept of the present disclosure, which is defined in the following claims, are also belong to the right scope of the present disclosure.

### DESCRIPTION OF SYMBOLS

| | |
|---|---|
| 100: Desulfurization part, | 111: First compressor, |
| 121: Branching part, | 200: Mixed reforming part, |
| 211: First heat exchange part, | 212: Second heat exchange part, |
| 213: Third heat exchange part, | 221: First pump, |
| 231: Merging part, | 300: Hydrogen separation part, |
| 311: First cooler, | 312: Liquid removing part, |
| 313: Second compressor, | |
| 400: Carbon monoxide separation part, | |
| 411: Pressure reducer (i.e., | |
| depressurization part), | |
| 412: Fourth heat exchange part, | |
| 500: Heat supply part, | 511: Third compressor, |
| 600: Carbon dioxide capturing part, | 601: Adsorption tower, |
| 602: Desorption tower, | 611: Fifth heat exchange part, |
| 612: Sixth heat exchange part, | 613: Second cooler, |
| 614: Second pump, | |
| 615: Seventh heat exchange part, | |
| 618: Third pump, | 619: Eighth heat exchange part, |
| 620: Fourth compressor, | 700: Power generation part, |
| 711: Ninth heat exchange part, | 712: Tenth heat exchange part, |
| 713: Third cooler, | 714: Fourth pump. |

What is claimed is:

1. A biogas reforming system comprising:
a desulfurization part configured to remove sulfur components from biogas;
a mixed reforming part configured to produce hydrogen (H₂) and carbon monoxide (CO) by performing a mixed reforming reaction on methane (CH₄) in the biogas, which has passed through the desulfurization part, with steam (H₂O) and carbon dioxide (CO₂);
a hydrogen separation part configured to separate hydrogen (H₂) from a reaction product from the mixed reforming part; and
a heat supply part configured to supply heat to the mixed reforming part by combusting the reaction product having passed through the hydrogen separation part, and a part of the biogas having passed through the desulfurization part.

2. The biogas reforming system of claim 1, further comprising:
a carbon monoxide separation part configured to separate carbon monoxide from the reaction product having passed through the hydrogen separation part,
wherein the heat supply part is further configured to combust the reaction product having passed through the carbon monoxide separation part, and a part of the biogas having passed through the desulfurization part.

3. The biogas reforming system of claim 1, wherein:
the desulfurization part operates under a pressure condition in a range of 1 to 30 bar and a temperature condition in a range of 20 to 500° C.

4. The biogas reforming system of claim 1, wherein:
the biogas having passed through the desulfurization part includes methane and carbon dioxide.

5. The biogas reforming system of claim 1, wherein:
the steam and the methane are supplied to the mixed reforming part with a molar ratio of the steam to the methane in a range of 0.2 to 1.5.

6. The biogas reforming system of claim 1, wherein:
the mixed reforming part operates under a pressure condition in a range of 0.5 to 15 bar and a temperature condition in a range of 700 to 1000° C.

7. The biogas reforming system of claim 1, further comprising:
a first heat exchange part configured to allow the biogas having passed through the desulfurization part and supplied to the mixed reforming part, and gas discharged from the heat supply part to exchange heat with each other.

8. The biogas reforming system of claim 1, further comprising:
a second heat exchange part configured to allow the biogas having passed through the desulfurization part and supplied to the mixed reforming part and the reaction product from the mixed reforming part to exchange heat with each other.

9. The biogas reforming system of claim 1, further comprising:
a third heat exchange part configured to allow the steam supplied to the mixed reforming part and the reaction product from the mixed reforming part to exchange heat with each other.

10. The biogas reforming system of claim 1, further comprising:
a liquid removing part provided between the mixed reforming part and the hydrogen separation part and configured to remove a liquid in the reaction product from the mixed reforming part.

11. The biogas reforming system of claim 1, further comprising:
a pressurization part provided between the mixed reforming part and the hydrogen separation part and configured to increase a pressure of the reaction product from the mixed reforming part and provide the reaction product to the hydrogen separation part.

12. The biogas reforming system of claim 2, further comprising:
a depressurization part provided between the hydrogen separation part and the carbon monoxide separation part and configured to decrease a pressure of the reaction product having passed through the hydrogen separation part, and provide the reaction product to the carbon monoxide separation part.

13. The biogas reforming system of claim 2, further comprising:
a fourth heat exchange part configured to allow the reaction product having passed through the hydrogen separation part and the reaction product from the mixed reforming part to exchange heat with each other.

14. The biogas reforming system of claim 1, further comprising:
a fifth heat exchange part configured to supply heat of gas, which is discharged from the heat supply part, to the desulfurization part.

15. The biogas reforming system of claim 1, further comprising:
a carbon dioxide capturing part configured to capture carbon dioxide from gas discharged from the heat supply part.

16. The biogas reforming system of claim 15, wherein:
the carbon dioxide capturing part is configured to capture the carbon dioxide by using absorption, adsorption, separation membrane, or cryogenic separation.

17. The biogas reforming system of claim 1, further comprising:
a power generation part configured to produce electricity by extracting waste heat from gas discharged from the heat supply part.
